(19) United States
(12) Patent Application Publication
(10) Pub. No.: US 2004/0219945 A1
(43) Pub. Date: Nov. 4, 2004

(54) Increasing effective number of data tones in a multi-tone communication system

(75) Inventor: John T. Coffey, San Francisco, CA (US)

Correspondence Address: TEXAS INSTRUMENTS INCORPORATED, P O BOX 655474, M/S 3999, DALLAS, TX, 75265

(73) Assignee: Texas Instruments Incorporated, Dallas, TX (US)

(21) Appl. No.: 10/696,045

(22) Filed: Oct. 29, 2003

Related U.S. Application Data
(60) Provisional application No. 60/467,431, filed on May 2, 2003.

(51) Int. Cl. H04B 7/24

(52) U.S. Cl. 455/550.1; 455/39

(57) ABSTRACT

A wireless device comprises host logic, network interface logic, and an antenna. The network interface logic transmits symbols containing a plurality of data tones and wherein the network interface logic varies the number of data tones among the symbols within a packet.

### CROSS-REFERENCE TO RELATED APPLICATIONS

This application claims priority to U.S. Provisional Application No. 60/467,431 filed May 2, 2003 and entitled “Method for Increasing Effective Number of Data Tones in a Multi-Tone Communication System,” incorporated herein by reference.

### BACKGROUND OF THE INVENTION

1. Technical Field

The present subject matter relates to communication networks and particularly to increasing the effective number of data tones in a multi-tone communication system.

2. Background Information

In general, communication systems permit data to be transmitted from one device to another coupled together either wirelessly or by a cable (electrical, fiber optic, etc.). All else being equal, it is generally desirable to provide a communication system that permits higher data rates. Defining a higher rate extension to current wireless local area network (“LAN”) systems while incorporating as much of current structure as possible also is desirable.

### BRIEF SUMMARY

In accordance with at least some embodiments, a wireless device comprises host logic, network interface logic, and an antenna. The network interface logic transmits packets comprised of symbols containing a plurality of data tones and wherein the network interface logic varies the number of data tones among the symbols within the packet.

### Notation and Nomenclature

Certain terms are used throughout the following description and claims to refer to particular system components. As one skilled in the art will appreciate, various companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

### BRIEF DESCRIPTION OF THE DRAWINGS

For a more detailed description of the preferred embodiments of the present invention, reference will now be made to the accompanying drawings, wherein:

FIG. 1 shows a wireless communication network;

FIG. 2 illustrates an embodiment in which the network varies the number of data tones among the symbols;

FIG. 3 illustrates a series of symbols with a variable number of data tones;

FIG. 4 shows a block diagram of a device used in the wireless network of FIG. 1;

FIG. 5 shows a block diagram of a transmitter used in the device of FIG. 3; and

FIG. 6 shows a block diagram of a receiver used in the device of FIG. 3.

### DETAILED DESCRIPTION OF THE PREFERRED EMBODIMENTS

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

Various communication systems use multiple frequencies over which to transmit data. The orthogonal frequency division multiplexed (“OFDM”) modulation technique employed in the IEEE 802.11 a wireless communication standard, for example, requires the implementation of 64 frequency “tones” (also called “bins”) spaced at intervals of 312.5 kHz. The 64 tones in the 802.11 a standard includes 48 data tones, 4pilot tones and 12 unused tones. A data tone is a tone on which data can be transmitted. A pilot tone is a tone used to aid in the coherent demodulation of the complex transmitted signal at the receiver as would be known by those of ordinary skill in the art. As such, pilot tones are not used to convey data. The 12 unused tones are included to prevent adjacent channel interference and also are not used to transmit data. This disclosure uses the 802.11 a channel structure as an example to illustrate various embodiments of the invention. However, the disclosure and claims that follow are not limited to any particular wireless standard.

FIG. 1 illustrates a communication network 50 implemented in accordance with a preferred embodiment of the invention. As shown, the network 50 comprises at least one access point (“AP”) 52 configured to be in wireless communication with at least one wireless station (“STA”) 54. Four wireless stations 54 are shown in the exemplary wireless LAN (“WLAN”) 50 of FIG. 1. The AP 52 includes a wired connection (not specifically shown) to a server or other suitable network device (also not shown). Additional APs 52 can be included as desired thereby permitting wireless stations 54 to wirelessly access a network via any of a plurality of APs. Devices 54 also may configured to communicate with each other in addition to communicating with the AP 52. The devices 54 may comprise desktop computers, notebook computers, computer-related equipment in general, or any type of device that is desired to be used in a communication network.

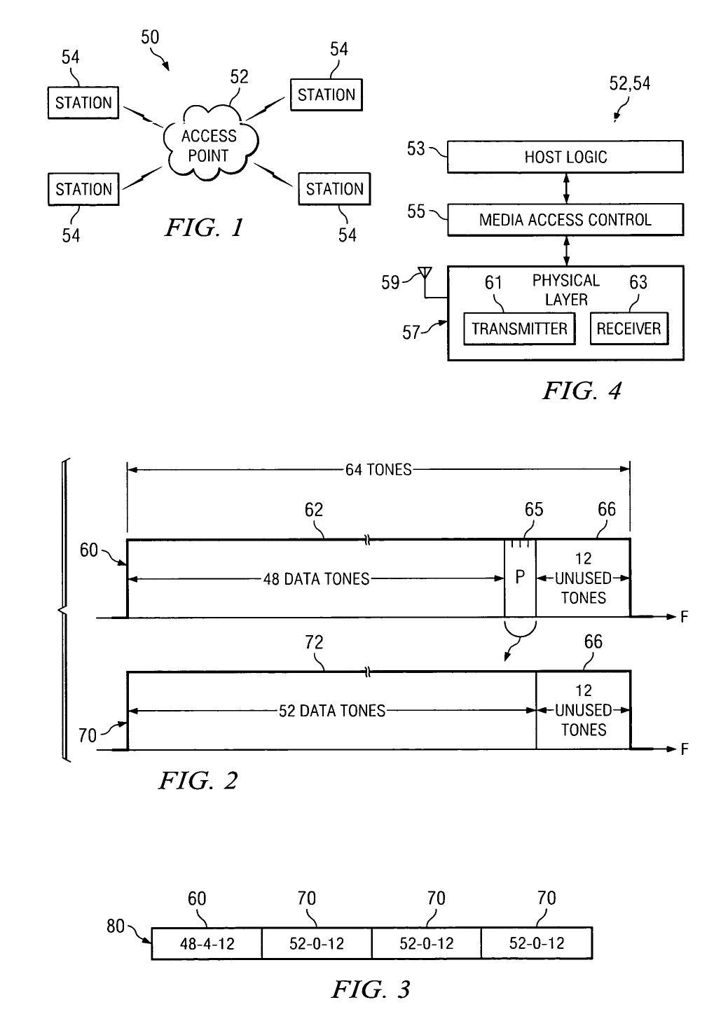

In accordance with a preferred embodiment of the invention, each AP 52 or STA 54 may form packets comprised of multiple OFDM “symbols” from data to be transmitted to another device. Each symbol comprises a plurality of data tones and the device (AP 52 or STA 54) preferably varies the number of data tones among the various symbols that are transmitted to another device. As such, some symbols may comprise more data tones than other symbols. FIG. 2 illustrates two exemplary symbols 60 and 70. Symbol 60 comprises 48 data tones (reference numeral 62), 4 pilot tones (65) and 12 unused tones (66) for a total of 64 tones. Symbol 70 comprises 52 data tones (72), no pilot tones, and 12 unused tones (66) also for a total of 64 tones. As shown, the number of unused tones may be the same between the symbols 60 and 70. The frequencies used for the pilot tones 65 in symbol 60 have been recruited to be used as data tones for symbol 70. Because symbol 70 has more data tones than symbol 60, all else being equai, symboi 70 advantageously is able to transmit more data than symbol 60.

As explained above, the pilot tones are used by the receiver of the symbol in the demodulation process and are not used to convey data. The wireless network generally will not work well without the pilot tones. However, in accordance with the preferred embodiments of the invention, not every transmitted symbol need have pilot tones. Thus, data may be transmitted from one device to another in the wireless communication network as symbols that may or may not have pilot tones.

FIG. 3 illustrates an exemplary sequence 80 of symbols 60, 70. As shown, the sequence comprises one symbol pattern 60 followed by three symbols of another pattern 70. As explained above with regard to FIG. 2, symbol pattern 60 comprises 48 data tones, 4 pilot tones, and 12 unused tones, while symbol pattern 70 comprises 52 data tones, no pilot tones, and 12 unused tones. The designation “48-4-12” on symbol 60 refers to 48 data tones, 4 pilot tones and 12 unused tones. The designation “52-0-12” on symbol 70 refers to 52 data tones, 0 pilot tones and 12 unused tones. The sequence 80 of four symbols results in an average number of data tones equaling 51. The tradeoff for increasing the average number of data tones is that some symbols have no pilot tones and the benefits provided by such pilot tones. However, in accordance with the preferred embodiments, devices that receive symbols with no pilot tones continue using the information obtained based on pilot tones from a previous symbol or set of symbols that did include pilot tones.

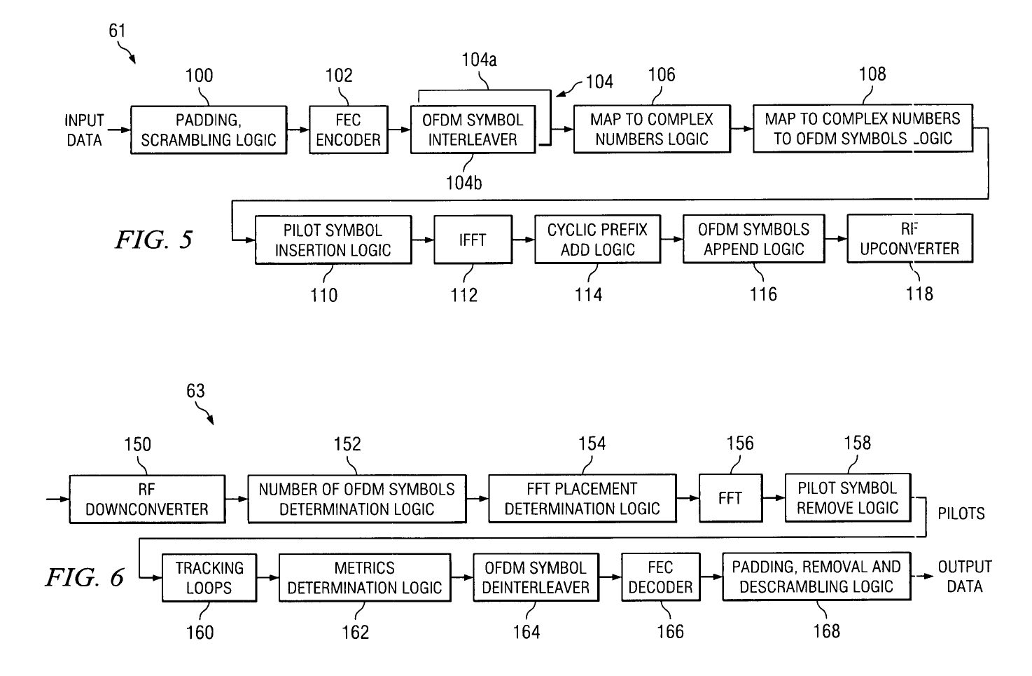

FIG. 4 shows an exemplary block diagram of an AP 52 or STA 54. As shown, the device 52, 43 preferably comprises host logic 53, a media access control (“MAC”) 55 and a physical layer (“PHY”) 59. The host logic 53 couples to the MAC 55 and the MAC couples to the PHY 57. The host logic 53 is specific to the functionality of the device 52. 54. The MAC 55 receives data from the host logic 53 and formats the data into packets that comport with the applicable protocol to which the network 50 adheres. For example, the MAC 55 may form a packet that includes data from the host logic 53 as well as a preamble and/or header that provides relevant routing information. The PHY 57 provides an antenna 59 through which the device 52, 54 wirelessly communicates with other devices in the network 50. The PHY 57 receives packets from the MAC 55 and processes the packets to help ensure successful transmission through the wireless network. Of course, packets from other devices are received by the PHY 57 and provided to the host logic 53 through the MAC 55. The PHY 57 comprises a transmitter 61 and a receiver 63 which are detailed below in FIGS. 5 and 6.

FIG. 5 shows an exemplary block diagram of the PHY's transmitter 61. As shown, transmitter 61 comprises padding and scrambling logic 100, forward error correction encoder 102, one or more symbol interleavers 104a, 104b (collectively referred to as “interleavers” 104), map to complex numbers logic 106, map complex numbers to OFDM symbols logic 108, pilot symbol insertion logic 110, inverse fast Fourier transformer (“IFFT”) 112, cyclic prefix add logic 114, OFDM symbol append logic 116, and RF upconverter 118.

The padding and scrambling logic 100 acts as follows. The padding logic adds “pad” bits at the end of the input data to accommodate encoder tailing and mapping to an integer number of OFDM symbols. The scrambling logic scrambles the data using a packet-specific seed, to ensure that if a retransmission is required, the transmitted packet will not be exactly the same.

The forward error correction (“FFC”logic 102 generally guards against data loss due to interference and multipath. Any suitable technique for performing forward error correction is acceptable. The FEC logic 102 receives the transmitted bit sequence from the padding and scrambling logic 100 as input to the encoder. The FEC logic 102 computes and outputs a corresponding set of coded bits, according to a deterministic rule.

The symbol interleavers 104 receive the encoded bits from the FEC encoder 102. Generally, the function performed by the interleavers 104 is to scramble the coded bits to combat fading. In general, an interleaver, such as an interleaver that is suitable for IEEE 802.11 a communications, takes the coded bits that will be mapped to a single OFDM symbol and “interleaves” (i.e., scrambles) the bits according to a known pattern. For example, for 802.11 a communications at 54 megabits per second, there are six coded bits per tone and 48 data tones. As such, there are 6×48=288 coded bits for each OFDM symbol. Therefore, for typical 802.11 a systems, the coded bit stream is divided into blocks of 288 bits and each 288 bit block is scrambled within itself.

In accordance with the preferred embodiments, however, the symbols have a variable number of data tones. For example, some symbols may have 48 data tones while other symbols have 52 data tones as explained above. Because of this variation in the number of data tones per symbol, the division of the coded bit stream must vary to correspond with the varying number of data tones. In the example of 48 data tones in some symbols and 52 data tones in other symbols, the 48 data tone symbols will have 288 coded bits. Each 52 data tone symbol, however, will have 6×52=312 bits. As such, two interleavers 104a and 104b are provided to accommodate 288 coded bits for some symbols and 312 coded bits for other symbols. Any suitable interleaving algorithm can be used for the interleavers 104.

The map to complex numbers logic 106 maps the interleaved bits to complex numbers in accordance with known techniques. The map complex numbers to OFDM symbols logic 108 preferably takes the set of mapped complex numbers and maps the complex numbers onto the data tones. Naturally, the mapping logic 108 will take into account the number and location in the frequency domain of the data tones.

The pilot symbol insertion logic 110 processes the mapped data to add pilot tones in accordance with the pilot tone requirements of the applicable symbol being generated by the transmitter. In the example given above, a symbol with 48 data tones will require four pilot tones, while a symbol with 52 data tones will not require any pilot tones.

The IFFT 112 converts the bits received from the pilot symbol insertion logic from the frequency domain to the time domain. The cyclic prefix add logic 114 generally duplicates the end portion of the time domain signal and prepends it to the beginning of the time domain signal. The cyclic prefix add logic 114 may be included to enable the frequency domain equalization that may be included in the receiver 63.

The OFDM symbol append logic 116 appends the time domain signals corresponding to each OFDM symbol one after another. Finally, the RF upconverter 118 converts the symbol to an appropriate RF signal for transmission across the wireless network.

FIG. 6 shows an exemplary block diagram of the PHY's receiver 63. As shown, receiver 63 RF downconverter 150, number of OFDM symbols determination logic 152, FFT placement determination logic 154, fast Fourier transformer (“FFT”) 156, pilot symbol remove logic 158, metrics determination logic 162, OFDM symbol deinterleaver 164. FEC decoder 166, and padding, removal and scrambling logic 168. The functional units shown in the receiver of FIG. 6 generally reverse the process described above and shown in FIG. 5.

The RF downconverter 150 receives the transmitted RF signal and demodulates the signal to recover the transmitted symbol. The number of OFDM symbols determination logic 152 receives the downconverted signal and, from the received signal, determines the number of symbols. The FFT placement determination logic 154 determines a suitable interval in which to take the samples from the received sequence in order to take the FFT for that symbol. The FFT 156 converts the signal from the FFT placement determination logic from the time domain into the frequency domain.

The pilot symbol remove logic 158 removes any pilot symbols that may be present. Symbols that have 48 data tones require four pilot tones to be removed, while symbols having 52 data tones do not have pilot tones, as described above, and thus do not require any pilot tone removal. The tracking loops 160 use information derived from pilot symbols to compensate for the cumulative effects of impairments and mismatches such as frequency offset.

The receiving device needs to know the pattern of how the number of data tones per OFDM symbol varies. There are several techniques to achieve this feature. One technique is for the access point (AP) to broadcast a single policy for the entire network in each beacon. This can be done by utilizing selected bits in the regularly transmitted beacon to select from a finite, predetermined list. Alternatively, a protocol for packet headers may be adopted in which the transmitter signals the policy for that packet in the packet header; the receiver decodes the header first and can apply the resulting pattern for the data payload. These techniques are given as examples only; the exact method is not essential for this disclosure.

The metrics determination logic 162 derives reliability information for bits at the input to the FEC decoder from the received signals on the data tones and from the channel estimates.

The OFDM symbol deinterleaver 164 generally reverses the process implemented by the symbol interleavers 104 of FIG. 5. The FEC decoder 166 decodes the encoded bit stream received from the OFDM symbol deinterleaver 164. Decoder 166 has knowledge of all of the coded bit sequences that can possibly result from the encoding process. The decoder preferably keeps a running comparison of the coded bit sequence that is recovered against all known coded bit sequences. The decoder 1646 retains the best matches and after a certain amount of data has been recovered, the decoder makes an estimate of the correct decoded bit sequence. By comparing the bit sequence recovered versus all known transmit coded bit sequences, the decoder 166 can predict the value of the original transmitted bit sequence. Armed with this information, the decoder can not only detect an error, but can also correct the error. The padding, removal and scrambling logic 168 reverses the procedure of [0021].

One or more advantages of the disclosed subject matter are possible. Flexibility is enabled by providing two basic symbol frameworks (48 and 52, for example). As such, the frame works can be mixed and matched to achieve a larger number of possible effective numbers of data tones per symbol. The second advantage is that of at least some of reuse of the conventional architecture is possible, in that (again in this example) every symbol that has pilot tones the same (old) number of pilot tones.

While the preferred embodiments of the present invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. For instance, more than two classes of device can be accommodated. Accordingly, the scope of protection is not limited by the description set out above. Each and every claim is incorporated into the specification as an embodiment of the present invention.

What is claimed is:

1. A wireless device, comprising:
host logic;
network interface logic; and
an antenna;
wherein the network interface logic transmits packets comprising symbols containing a plurality of data tones and wherein the network interface logic varies the number of data tones among the symbols.

2. The wireless device of claim 1 wherein some symbols transmitted by the network interface logic comprise pilot tones that are used to facilitate demodulation and other symbols do not have pilot tones.

3. The wireless device of claim 2 wherein some symbols comprise 48 data tones and 4 pilot tones and other symbols comprise 52 data tones and no pilot tones.

4. The wireless device of claim 1 wherein the number of data tones is varied according to user input.

5. The wireless device of claim 1 wherein the network interface logic varies the number of data tones per symbol within a packet so as to comprise either a first number of data tones or a second number of data tones, and wherein the first number is greater than the second number and more symbols per packet are transmitted by the network interface logic having the first number of data tones.

6. A wireless network, comprising:
a first wireless device;
a second wireless device configured to communicate with the first wireless device;
wherein the first wireless device transmits to the second wireless device packets containing symbols containing a variable number of data tones.

7. The wireless network of claim 6 wherein the second wireless device transmits to the first wireless device packets containing symbols containing a variable number of data tones.

8. The wireless network of claim 6 wherein some symbols in a packet transmitted by the first wireless device comprise pilot tones that are used to facilitate demodulation and other symbols do not have pilot tones.

9. The wireless network of claim 8 wherein some symbols in a transmitted packet comprise 48 data tones and 4 pilot tones and other symbols comprise 52 data tones and no pilot tones.

10. The wireless network of claim 6 wherein the number of data tones is varied among the symbols in a packet according to user specification.

11. The wireless network of claim 6 wherein the first wireless device varies the number of data tones per symbol within a packet so as to comprise either a first number of data tones or a second number of data tones, and wherein the first number is greater than the second number and more symbols per packet are transmitted by the first wireless device having the first number of data tones.

12. A method, comprising:
determining a number of data tones to include in a symbol;
forming the symbol with the determined number of data tones;
transmitting the symbol; and
changing the number of data tones to form another symbol.

13. The method of claim 12 wherein the number of data tones comprises either a first number of data tones or a second number of data tones.

14. The method of claim 12 further comprising varying a number of pilot tones.

15. The method of claim 12 wherein forming the symbol comprises including 48 data tones and 4 pilot tones and varying the number of data tones comprises including 52 data tones and the method further comprises including no pilot tones with the 52 data tones.

16. A wireless device; comprising:
host logic;
an antenna; and
means for transmitting symbols containing a plurality of data tones and for varying the number of data tones among the symbols.

17. The wireless device of claim 16 further comprising means for varying the number of pilot tones among the symbols.

18. The wireless device of claim 16 wherein the means for varying the number of data tones comprises means for varying the number of data tones according to user input.

19. The wireless device of claim 16 wherein the means for varying the number of data tones comprises means for varying the number of data tones so as to comprise either a first number of data tones or a second number of data tones.
